(19) United States
(12) Patent Application Publication
(10) Pub. No.: US 2009/0315321 A1
(43) Pub. Date: Dec. 24, 2009

(54) DATA STORAGE CARD HAVING A LENTICULAR IMAGE FEATURE AND METHOD FOR MAKING SAME

(75) Inventors: Maxmillian D. Michieli, Parker, CO (US); Anthony J. Batoha, Littleton, CO (US)

Correspondence Address: MARSH, FISCHMANN & BREYFOGLE LLP, 8055 East Tufts Avenue, Suite 450, Denver, CO, 80237, US

(73) Assignee: CPI CARD GROUP, INC., Littleton, CO (US)

(21) Appl. No.: 12/141,813

(22) Filed: Jun. 18, 2008

(51) Int. Cl. B42D 15/00; B32B 37/14

(52) U.S. Cl. 283/111; 156/277

(57) ABSTRACT

A data storage card having a lenticular image feature and a method for fabricating a data storage card. The data storage card can include multiple material layers that are heat laminated so that the data storage card resists delamination of the material layers during use. A lenticular lens array is printed on a front surface of the data storage card, whereby an interlaced image is visible through the lenticular lens array and through an underlying optically clear substrate to create a lenticular image feature. The data storage card can be an identification card, such as a financial transaction card.

### BACKGROUND OF THE INVENTION

1. Field of the Invention

This invention relates to the field of data storage cards. In particular, the present invention relates to data storage cards having a lenticular image feature and to a method for making data storage cards having a lenticular image feature.

2. Description of Related Art

Data storage cards such as credit cards, debit cards and gift cards are being used with increasing frequency in today's society. Data storage cards enable the rapid identification of the cardholder and/or the association of an account with the cardholder, such as to purchase merchandise or services using the information encoded on the data card. The data storage card typically includes a magnetic strip, a bar code or similar feature that contains readable data. Relevant information such as a card number can also be embossed on a surface of the data storage card for use when electronic or optical data reading equipment is not available at the point of use.

The issuers of such data storage cards, such as financial institutions and retailers, are continually attempting to incorporate unique visual features into the data storage cards to make the cards more aesthetically attractive to the consumer, thereby encouraging the consumer to select their data storage card in lieu of a competitor's card. Thus, the incorporation of a prominent and distinctive visual feature can give the card issuer a significant commercial advantage.

However, the incorporation of some otherwise desirable visual features can be difficult to implement since many data storage cards comprise multiple material layers, and are required to meet stringent physical standards with respect to the card dimensions and the physical and optical properties of the card. Even for data storage cards that are not required to meet such rigorous standards, many card issuers nonetheless prefer to meet or exceed many of the relevant standards to ensure that the issued card will be durable and will not require frequent replacement by the card issuer.

The standards set forth by the International Organization for Standardization in ISO 7810 relate to several formats of identification cards. Identification cards are cards that identify both the bearer of the card and the issuer of the card, and all financial transaction cards such as credit cards and debit cards are classified as identification cards under this standard. The ID-1 format of ISO 7810 specifies a card size of 3⅜×2⅛″ (85.60 mm×53.98 mm), which is commonly used for banking cards, such as credit cards and debit cards.

The ISO also sets forth rigorous standards to ensure that certain types of data storage cards are robust and will not become unusable when subjected to a wide variety of conditions, such as exposure to elevated temperatures, to elevated humidity and/or to bending stresses. For example, ISO compliant cards must be resistant to delamination of the various layers that constitute the card, and the ISO standards for many such cards require that each layer in the card structure have a minimum peel strength of 3.4 lb·ft/in (6 N/cm). The cards must also be resistant to tampering, such as by removing security features from the surface of the card. To achieve sufficient bond strength among the various layers of a card, it is common to laminate the layers by applying heat and pressure to a collated stack of material layers during the card manufacturing process to form a bond between adjacent layers. As a result, some aesthetic features are difficult to incorporate into the card while maintaining the robust physical properties of the card.

### SUMMARY OF THE INVENTION

It is one object of the present invention to provide a method for the manufacture of a data storage card having a lenticular image feature. The method can enable the lenticular image feature to be formed onto a wide variety of data storage cards, including ISO compliant cards such as secure financial transaction cards, including cards that comprise other features such as embossed characters, or a hologram for additional security.

Such a method for the manufacture of a data storage card having a lenticular image feature can include the step of printing an image layer comprising an interlaced image on a back surface of a substrate, the substrate comprising an optically transparent material. The substrate can be collated with at least a first overlay film to form a multilayer collated stack and the collated stack can be heat laminated to form a laminated stack. A lenticular lens array can then be printed over a front surface of the laminated stack, whereby the interlaced image can be viewed through the lenticular lens array to form a data storage card having a lenticular image feature.

The image layer can be printed using reverse printing of an image onto the back surface of the substrate, for example by using lithographic printing. The optically transparent material can be a polymer material such as polyvinyl chloride (PVC) and in one aspect the substrate has a thickness of at least about 24 mils and not greater than about 30 mils.

One method for printing the lenticular lens array over the front surface of the substrate is to screen-print an ink onto the front surface and cure the ink to form the lenticular lens array. For example, the ink can be an ultraviolet (UV) curable ink that is printed onto the front surface and is cured using UV radiation. By printing the lenticular lens array onto the front surface of the laminated stack, the lens array can be formed into a pre-determined pattern whereby a portion of the front surface is not covered by the lenticular lens array, which forms a flush and smooth portion on the front surface. In this regard, the method can also include the step of applying a material layer such as a hologram to the flush portion of the front surface.

To enhance the visibility of the lenticular image feature, an optically opaque material can be applied behind the image layer. The optically opaque material can also be opaque to infrared (IR) radiation to enable the data storage card to be used in devices such as ATMs.

The collating step can include placing a front overlay film over a front surface of the substrate and placing a back overlay film under a back surface of the substrate behind the image layer. The heat laminating step can include placing the collated stack between two platens and applying elevated pressure and heat for a period of time sufficient to heat laminate the collated stack. In one aspect, each of the layers of the collated stack has a peel strength of at least about 3.4 lb·ft/inch (6 N/cm) between layers. The front overlay film and back overlay film are particularly adapted to inhibit tampering with the card and will typically have a thickness that is less than the thickness of the substrate.

A method for the manufacture of a data storage card can also include the step of printing an image layer including an interlaced image on a back surface of a substrate, where the substrate includes an optically transparent polymer material. An optically opaque material can be applied behind the interlaced image. The substrate, a front overlay film and a back overlay film can then be collated to form a multilayer collated stack. The collated stack can be heat laminated to form a laminated stack. A curable polymer ink is then printed onto the front of the laminated stack such as by screen-printing in a pattern that is adapted to form a lenticular lens array. The ink is then cured to form a lenticular lens array over the front of the laminated stack, whereby the interlaced image can be viewed through the lenticular lens array.

In accordance with the foregoing method, the polymer ink can be screen-printed over the front of the laminated stack in a pre-determined pattern, whereby at least a portion of the front of the laminated stack is not covered by the lenticular lens array. In this manner, a material layer can be applied to the front of the laminated stack such as by hot stamping the material layer onto the portion that is not covered by the lenticular lens array.

An identification card having a lenticular image feature is also provided. The identification card can include a substrate having a front surface and an opposed back surface, where the substrate comprises an optically transparent material. An image layer including an interlaced image is reverse printed on the back surface of the substrate. A lenticular lens array is disposed over the front of the substrate, whereby the interlaced image can be viewed through the lenticular lens array and the substrate. An opaque layer can be disposed behind the image layer, and a front overlay film can be heat laminated to the front side of the substrate. Preferably, the lenticular lens array is disposed directly on the front overlay film, particularly with no adhesive layer disposed between the front overlay film and the lenticular lens array.

### DESCRIPTION OF THE DRAWINGS

FIG. 1 illustrates a front plan view of a data storage card.

FIG. 2 illustrates a rear plan view of a data storage card.

FIG. 3 illustrates a cross-sectional view of a data storage card taken along line A-A of FIG. 1.

FIG. 4 is a flow sheet illustrating a method for fabricating a data storage card.

FIG. 5 is a flow sheet illustrating a method for printing a lenticular lens array.

### DESCRIPTION OF THE INVENTION

The present invention relates broadly to data storage cards and methods for the manufacture of data storage cards. As used herein, a data storage card is a card that carries readable data, such as data capable of identifying an account associated with the card, the issuer of the card and/or the bearer of the card. Non-limiting examples of data storage cards include credit cards, debit cards, gift cards, phone cards, loyalty cards such as those utilized by airlines, hotels and other retailers to track and reward customer usage, personal identification cards, permit cards such as a driver's license and access control cards. The readable data can be stored on the card in one or more of a variety of forms including, but not limited to, magnetically readable data such as that stored on a magnetic stripe, optically scannable data such as in the form of a bar code, embossed alphanumeric characters or an embedded microchip or transponder, such as an RFID tag, in the case of a smart card.

One type of data storage card is referred to as an identification card. An identification card is a card that identifies both the bearer of the card and the issuer of the card and the requirements for identification cards are set forth in ISO 7810. An identification card can also carry other data to facilitate, for example, financial transactions. ISO 7810 defines several formats for identification cards, including an ID-1 format that is commonly used for financial transaction cards, e.g., common debit and credit cards. The ID-1 format specifies a size of 3⅜″×2⅛″ (85.60 mm×53.98 mm).

A financial transaction card is defined by ISO as an identification card having the ID-1 size format under ISO 7810 that also meets the requirements of ISO 7813, which is a subset of ISO 7810. ISO 7813 sets forth standards to ensure that financial transaction cards are uniform in size, are durable and are secure. Financial transaction cards under ISO 7813 have a nominal thickness of about 30 mils (0.76 mm) and corners rounded to a radius of about 125 mils (3.18 mm), a size format also referred to as CR-80.

The data storage cards disclosed herein include a lenticular image feature, which can enhance the aesthetic value of the data storage card. A lenticular image feature includes a lenticular lens array and an image disposed under the lens array that can be viewed through the lens array. The lenticular image is created by observing the underlying image through the lenticular lens array to produce an illusion of depth (i.e., three-dimensions), or the ability to change or move an image as the lenticular image is viewed by an observer from different viewing angles. To create a lenticular image, two or more separate images can be combined into a single image file in a process referred to as interlacing, which is typically done using digital images. The interlaced image can include alternating narrow parallel strips of each image, where a strip of each image is disposed beneath a column of lenticules in the lenticular lens array. Alternatively, a single image can be offset and the offset images interlaced to produce a three-dimensional effect that arises due to the spacing between the eyes of the observer. In either case, when the interlaced image is viewed through a lenticular lens array, a motion effect, image change, or a three-dimensional effect can be perceived by the viewer. The image can be, for example, a photograph, a drawing, a logo or any similar feature.

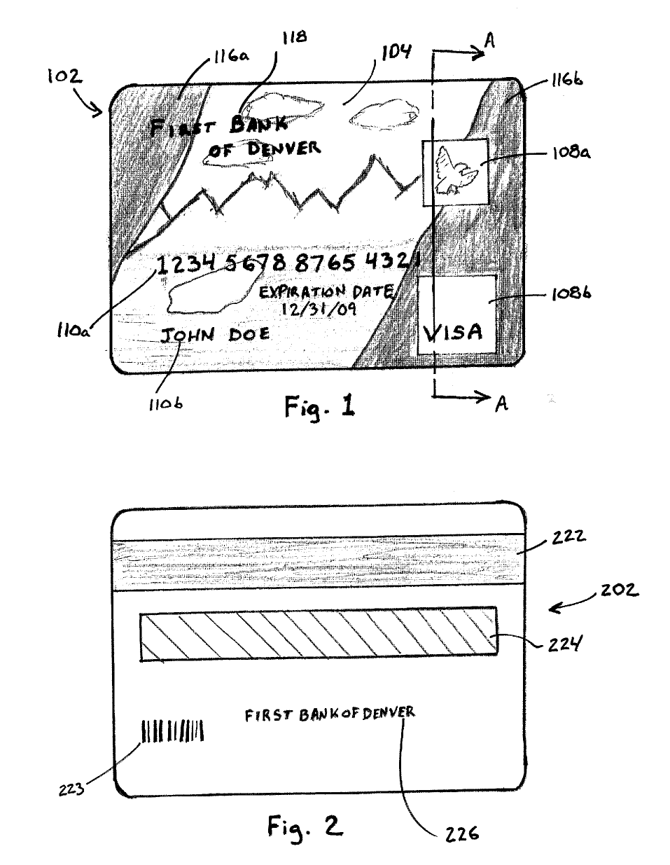

FIG. 1 illustrates a front plan view of a data storage card having a lenticular image feature formed by a lenticular lens array and an underlying interlaced image. The data storage card 102 can be generally rectangular in shape with rounded corners and in one aspect substantially conforms to the shape and size requirements of ISO 7810 and ISO 7813 for a CR-80 financial transaction card. A lenticular lens array 104 can be disposed over at least a portion of the front of the data storage card 102. An interlaced image that is printed below the lenticular lens array 104 can be viewed through the lenticular lens array 104 to create a lenticular image feature that is visible to an observer looking at the card. As illustrated in FIG. 1, and only by way of example, the lenticular image feature forms a three-dimensional (stereoscopic) view of mountain scenery on the front of the card 102. In this instance, the underlying interlaced image can be derived from a single image of the mountain scenery where two copies of the mountain scenery image are off-set and interlaced. Alternatively, the mountain scenery image could be interlaced with a completely different image so that the image perceived by the observer changes as the observer's viewing angle relative to the front of the data storage card changes.

The lenticular lens array can cover the entire front surface of the data storage card, or a portion of the front surface of the data storage card. As illustrated in FIG. 1, the lenticular lens array 104 covers only a portion of the front of the data storage card 102, and the front of data storage card 102 also includes other material layers. For example, the data storage card illustrated in FIG. 1 includes a hologram 108a on the front of the card, where the lenticular lens array completely or partially surrounds the hologram. Features such as hologram 108a are often included on the surface of a data storage card, particularly a financial transaction card, to provide authentication of a genuine card. A hologram 108a or similar feature can advantageously be applied to a flush portion of the front surface of the data storage card 102—that is, a portion of the surface that is not covered by the lenticular lens array 104. Thus, the lenticular lens array 104 can be patterned such that portions of the front surface of the data storage card 102 are not covered by the lenticular lens array 104. This can advantageously enable material layers such as a hologram 108a to be well adhered to the smooth underlying surface. Due to the relatively rough surface of the lenticular lens array 104, a material layer placed directly on the lens array, such as by hot stamping, will not be securely adhered and will be prone to peeling from the card surface.

Further, other flush portions of the front of the card 102 can be provided, such as flush portions 116a and 116b, to enhance the aesthetic appearance of the data storage card 102. Since these flush portions do not include a lenticular lens array, they will be visually distinct from the lenticular image feature. Flush portions could be in the shape of alphanumeric characters or in the shape of a logo, for example logo 108b that is disposed on or below the front surface of the data storage card. Selective placement of the lenticular lens array can also reduce material costs as compared to covering the entire surface with the lens array. Nonetheless, the lenticular lens array can also be disposed over the entire front surface of the data storage card, if desired.

The data storage card 102 can also include one or more alphanumeric features, such as the account number 110a, cardholder name 110b or other information relevant to the bearer and/or issuer of the data storage card 102. Alphanumeric features can be embossed into the card, or can be printed as part of the image layer, including the lenticular image feature. Other features that can be included on the data storage card 102 include, for example, a photograph of the card bearer, which could also form part of the lenticular image feature.

Thus, the data storage card advantageously includes an aesthetically pleasing lenticular image feature, while also enabling the secure application of other material layers on the card surface and enabling the data storage card to be embossed to encode other information into the card.

FIG. 2 illustrates a plan view of the back surface of a data storage card 202. The data storage card 202 can include a magnetic strip 222 that can be encoded with data relating to the bearer and/or issuer of the data storage card 202 such as an account number and related information. Other means for storage of such data on the data storage card can include, but are not limited to, a scannable bar code 223, a computer chip in the case of a smart card, or an RFID tag. The back of the data storage card 202 can also include other features such as a signature block 224 adapted to receive the card bearer's signature. Alphanumeric features 226 can also be included on the back side of the data storage card 202 to provide additional relevant information. Although these features are illustrated as being disposed on the back of the data storage card 202, such features can also be disposed on the front of the data storage card as may be desired. By way of example only, some identification cards include a computer chip or an RFID tag on the front of the card. Further, although the lenticular image feature is described herein as being disposed on the front of the data storage card, a lenticular image feature can also be disposed such that it is visible on the back surface of the data storage card, in addition to or in lieu of the front surface.

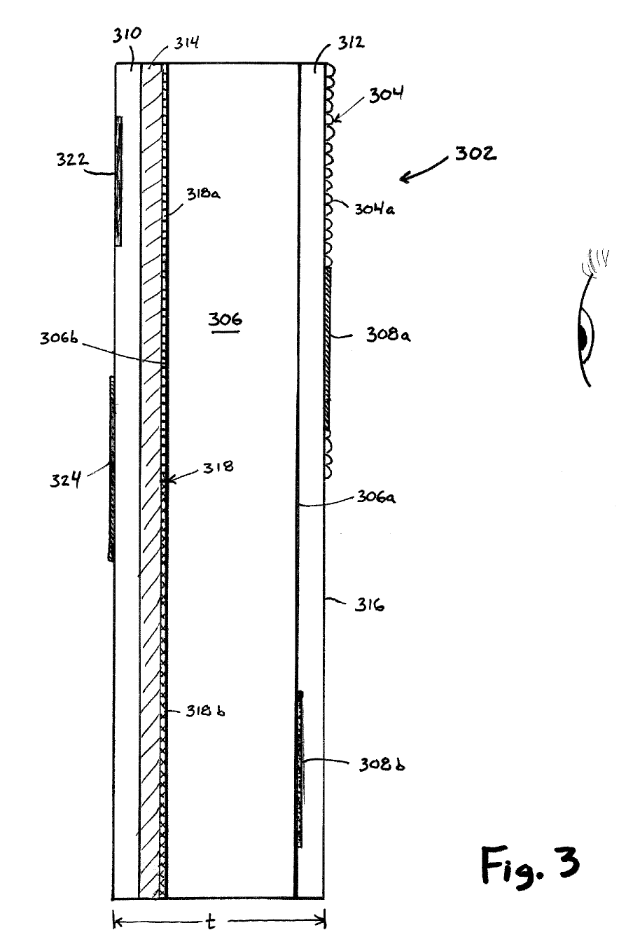

FIG. 3 illustrates a cross-sectional view of a data storage card taken along line A-A of FIG. 1. Unless otherwise indicated, the thickness of the material layers illustrated in FIG. 3 are not to scale and the dimensions are generally exaggerated for purposes of illustration.

The data storage card 302 can include a substrate 306 that forms the core of the data storage card 302 and includes a front surface 306a and an opposed back surface 306b. The substrate 302 can be fabricated from a variety of materials, and polymer materials are particularly useful for the substrate 306. Examples of polymer materials that can be used for the substrate 306 include, but are not limited to, polyvinyl chloride (PVC), polyester, polyethylene terephthalate (PET), polycarbonate or similar plastic materials. The substrate 306 provides the relatively thick, rigid or semi-rigid support upon which the remaining material layers are disposed. The substrate material can be optically transparent to enable at least the interlaced image 318a to be viewed through the substrate 306 and through the lenticular lens array 304 to form the lenticular image feature. For financial transaction cards or similar data storage cards, the substrate can have a thickness of from about 24 mils to about 30 mils, such as about 27 mils (where 1 mil=0.001 inches).

Although the substrate 306 is illustrated as a single unitary material layer, the substrate can also be fabricated from two or more material layers that are stacked and subsequently bonded together, such as by heat lamination. By way of example, two substrate layers each having a thickness of about 13.5 mils each can be stacked and laminated to form a substrate having a total thickness of about 27 mils.

An image layer 318 is disposed on the substrate 306, such as on the back surface 306b of the substrate. For example, the image layer 318 can be printed directly onto the back surface 306b of the substrate. However, other material layers can be disposed between the substrate 306 and the image layer 318, as long as such additional material layers do not interfere with the desired view of the image layer 318 from the front of the data storage card 302. The image layer 318 can cover all or a portion of the substrate 306, as may be desired, and typically the image layer will cover substantially the entire surface of the substrate 306.

The image layer 318 includes one or more interlaced images, such as interlaced image 318a. When the interlaced image 318a is viewed through the lenticular lens array 304 on the front of the card, a lenticular image feature is formed. For example, three-dimensional mountain scenery (FIG. 1) can be formed from an interlaced image 318a. However, alphanumeric characters, for example, can be printed over the interlaced image 318a in a normal (non-interlaced) fashion. Other non-interlaced portions can include non-interlaced images or portions that are simply colored, such as portion 318b. Alternatively, the entire image layer can consist of an interlaced image such that the entire front surface of the card includes a lenticular image feature.

An image layer can also be disposed over the front of the substrate 306. For example, alphanumeric characters, logos or other indicia can be printed onto the front surface 306a of the substrate. As illustrated in FIG. 3, a logo 308b is printed on the front surface 306a of the substrate and is visible from the front of the data storage card 302. However, it is preferred that the interlaced image is printed on the back surface of the substrate, as the thickness of the substrate enhances the lenticular effect by increasing the length of the optical axis.

To enhance the visibility of the image layer 318, including the interlaced image 318a, an optically opaque layer 314 can be disposed behind the image layer 318, i.e., on the side of the image layer that is opposite the lenticular lens array. The optically opaque layer 314 can be substantially opaque to visible wavelengths of light to enhance the visibility of the image layer. The optically opaque layer 314 can also, or alternatively, be substantially opaque to infrared (IR) wavelengths of radiation such that the data storage card 302 can be detected when placed in electronic reading machinery such as an automated teller machine (ATM). The opaque layer 314 can comprise a plastic film layer that is similar to or compatible with the substrate material, where the opaque layer 314 includes opacifying agents adapted to block or scatter radiation in the visible and/or infrared ranges. The opaque layer can also be printed onto the back of the image layer 318, such as by screen-printing. The opaque layer 314 can also include multiple layers, such as layers that are sequentially printed. For example, a layer of optically opaque material can be printed over the image layer 318 and a layer of IR opaque material can then be printed over the optically opaque layer. The opaque layer can cover all or a portion of the back of the image layer. Alternatively, the card may not include such an opaque layer, such as when an optically transparent card is desired.

The back surface of the opaque layer 314 can also include alphanumeric characters or other indicia printed thereon, such that the indicia are visible when observing the back surface of the data storage card 302. Examples include, but are not limited to, the bar code 223 and alphanumeric characters 226 illustrated in FIG. 2.

The data storage card can also include a back overlay film 310 that is disposed over the back surface 306b of the substrate, such as over the back of the opaque layer 314. The back overlay film 310 can cover alphanumeric characters and indicia, if any, printed on the back surface of the opaque layer 314 to inhibit tampering with such indicia. The back overlay film 310 can be fabricated from a polymer, such as a polymer that is similar to the substrate material. Examples include, but are not limited to, PVC, polyester, PET, polycarbonates or similar plastic materials. The back overlay film 310 can have a thickness of from about 1.8 mils to about 2 mils, for example.

In addition, a front overlay film 312 can be disposed over the front of the substrate 306. The front overlay film 312 can have similar properties to the back overlay film 310, and can also be fabricated from a polymer such as PVC, polyester, PET, polycarbonates or similar plastic materials. The front overlay film 312 can also have a thickness of from about 1.8 mils to about 2 mils, for example.

The overlay films 310 and 312 are adapted to provide additional security for the data storage card by inhibiting tampering with the card, for example by removing or altering information on the card that underlies the film(s) such as information printed on the front surface 306a of the substrate or the back of the opaque layer 314. The overlay films can also enhance the durability and useful lifetime of the data storage card 302. Such overlay films are typically necessary for the data storage card to meet the ISO requirements for identification cards, particularly for financial transaction cards.

As is noted above, a lenticular lens array 304 can be disposed over at least a portion of the front surface of the data storage card, such as over the front overlay film 312. For example, the lenticular lens array 304 can be disposed directly on the front overlay film 312, and preferably with no intervening adhesive layer between the front overlay film 312 and the lenticular lens array 304.

The lenticular lens array 304 includes a plurality of lenticules 304a that are disposed on the front of the data storage card 302 in an array that, through proper registration with the underlying interlaced image 318a, creates a lenticular image feature. The lenticular lens array 304 is optically transparent and can be fabricated from an optically transparent polymer material, for example. To ensure durability of the card and the lenticular image feature, the polymer material can have a high abrasion resistance to resist abrasion of the surface during use of the card.

The front of the data storage card 302 can also include one or more flush portions, such as portion 316, where the lenticular lens array 304 does not cover the surface. Additional material layers, such as a hologram 308a, can advantageously be disposed on the front surface of the data storage card over such a flush portion. As is noted above, placing such material layers on a flush (smooth) portion of the card surface enables the material layer to be well adhered to the underlying surface.

In addition, the back surface of the data storage card 302 can include features such as magnetic stripe 322 and signature block 324.

In one aspect, the data storage card 302 can have a total thickness (t), including the lenticular lens array, of from about 27 mils to about 33 mils, and in one aspect meets the ISO thickness requirements for a financial transaction card. The data storage card 302 can also meet other ISO requirements for a financial transaction card. For example, the layers in the structure of the data storage card 302 can each have a minimum peel strength of 3.4 lb·ft/inch (6 N/cm).

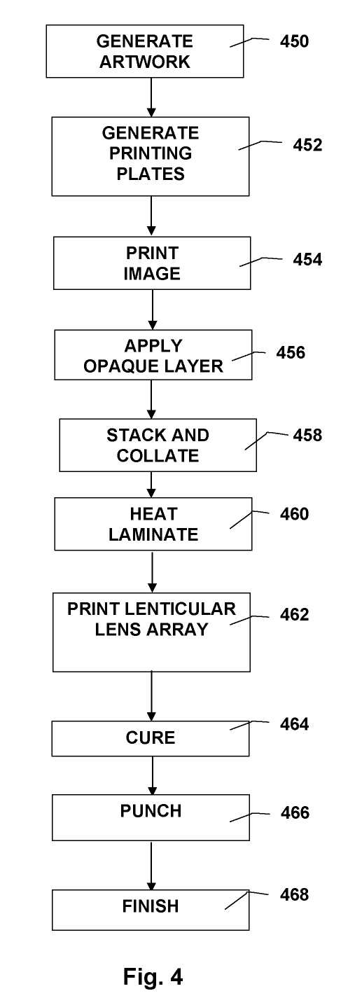

FIG. 4 is a flow sheet illustrating a method for the manufacture of a data storage card having a lenticular image feature. Artwork is generated 450 that includes the interlaced image(s) that are viewed through the lenticular lens array. The artwork can include two or more different images that are combined to form an interlaced image that is to be used in conjunction with the lenticular lens array. A different image will then be visible to the observer depending on the viewing angle of the observer. Alternatively, or in addition to, the artwork can include a single image that is off-set and then interlaced to produce a three-dimensional effect regardless of the viewing angle of the observer. It will be appreciated that the artwork can include any combination of three-dimensional images and/or changing images.

Interlacing of the images involves splicing the images into a large number of thin slices, and then combining the images into a single composite image comprised of alternating slices of each image. The parameters for interlacing the images to form the interlaced image include the pitch of the lenticules that form the lenticular lens array. That is, the images should be interlaced such that a portion of each image is disposed beneath each column of lenticules in the lenticular lens array. In order to ensure that the interlaced images will be properly registered and disposed beneath the subsequently printed lenticular lens array, the shrinkage that occurs during the heat lamination step, discussed below, should be taken into account. Thus, the images should be slightly enlarged to account for this subsequent shrinkage. In this manner, the final laminated interlaced image will substantially match the pitch of the lenticular lens array.

The artwork can also include portions of the image layer that are not interlaced. Examples can include alphanumeric characters or other portions where a lenticular image feature is not desired.

The artwork can then be utilized to generate printing plates 452, such as lithographic printing plates that can be utilized to simultaneously print a plurality of data storage cards on a single material sheet, such as optically transparent PVC. Typically, data storage cards are fabricated in large sheets where the sheets each include an array of identical cards, such as 56 cards to a sheet. After fabrication, the individual cards are separated from the sheet, such as by punching.

When the image layer is printed over the back surface of the substrate, the printing plates that are generated from the artwork are generated in reverse (mirror image) to account for the second surface printing onto the optically transparent substrate. That is, the artwork must be reverse printed since it will be printed on the back of the substrate and in use will be observed through the thickness of the substrate from the front side of the substrate.

An image layer including an interlaced image is then printed 454 onto the back surface of an optically transparent substrate, such as by a lithographic printing process. The front surface of the substrate can also be printed, such as to print alphanumeric characters, logos or other indicia onto the front surface such that the indicia will be visible on the front surface of the card.

An opaque layer can then be applied 456 over the back of the image layer, including the interlaced image. The opaque layer can be optically opaque to enhance the visibility of the image, and/or can be opaque to infrared (IR) radiation, for example, to enable the data storage card to be used in an ATM or similar card-reading device. The opaque layer can be printed onto the image layer by screen-printing, for example. Alternatively, the opaque layer can be formed from a film of material, such as a material that is similar to the material of the optically transparent substrate, but that includes opacifying agents or other pigments to provide optical and/or infrared opacity.

In order to provide a data storage card such as a financial transaction card that is durable and secure, a polymer overlay film can be placed over one or both sides of the substrate. The overlay films can comprise the same or similar material as the substrate, such as PVC, and the overlay films can have a thickness, for example, in the range of about 1.8 mils to 2 mils. The back overlay film can optionally have a magnetic stripe embedded into the film.

The substrate and overlay films can then be collated by stacking and registering the material layers 458, and then heat laminating the collated stack 460 to securely laminate the films to the substrate and form a laminated stack. The heat laminating step 460 can include the application of heat and pressure for a period of time to securely laminate the overlay films to the substrate. For example, a laminating pressure of at least about 150 psi, such as from about 170 psi to about 320 psi can be applied at a laminating temperature of at least about 250° F., such as from about 285° F. to about 330° F. The laminating pressure and laminating temperature can be applied for a period of time, such as from about 16 to about 20 minutes to ensure that the polymer overlay films are well laminated to the substrate. For example, the heat and pressure can be applied using a platen press. The platens of the platen press can have a smooth surface so that the resulting data storage card has a glossy appearance, a heat lamination process referred to as press polishing. Alternatively, one or both of the platens can have a matte finish to provide the card with a matte appearance on one or both sides of the data storage card. In either case, the heat lamination step laminates the overlay films to the underlying substrate so that the card is not susceptible to delamination under a wide range of conditions and is resistant to tampering.

After heat laminating at the desired laminating pressure and laminating temperature, the data storage cards are cooled. For example, the data storage cards can be transferred to a cooling platen press, whereby the cards are cooled while being subjected to increasing pressure during the cooling period. For example, the pressure applied by the cooling press can be gradually increased as the data storage cards are gradually cooled to inhibit delamination of the layers during the cooling period.

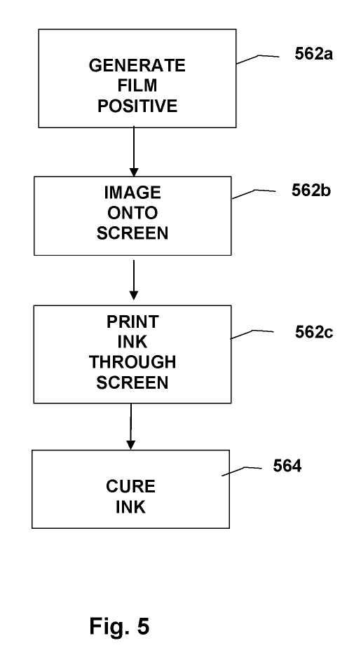

After heat lamination 460, the lenticular lens array can be printed 462 onto the front surface of the laminated stack, such as by printing the lenticular lens array directly on the front overlay film. The lenticular lens array can be printed by a variety of methods, including non-contact methods such as ink-jet printing of an ink. In one particular embodiment, the lenticular lens array is printed onto the substrate by screen-printing of a curable polymer ink, as is described below with respect to FIG. 5.

After printing 462 and curing 464 of the lenticular lens array, individual data storage cards can be punched 466 from the sheet. After punching, the individual cards can be subjected to finishing operations 468 which can include hot stamping of additional material layers, such as holograms or logos, embossing and foil tipping, application of a signature panel and other finishing operations. The data storage cards advantageously can accommodate these processes by patterning the lenticular lens array to leave flush portions adapted to receive material layers such as holograms and the like. The lenticular lens array can also be sufficiently flexible to substantially avoid chipping during the punch press and embossing processes.

FIG. 5 is a flow sheet that illustrates a screen-printing method for applying a lenticular lens array to the substrate (e.g., step 462 of FIG. 4).

Screen-printing of the lenticular lens array generally requires control over the registration of the lens array with the underlying interlaced image. Proper registration to the heat laminated stack is important since if the lens array is not properly registered over the interlaced image, the images will appear out of focus, distorted or illegible. As is noted above, the shrinkage of the laminated stack during heat lamination is also accounted for in designing both the lithographic artwork and the screen printed lens array.

Screen-printing first involves preparation of a screen-printing stencil for screen-printing the lenticular lens array. The screen mesh, thread diameter and mesh thickness is selected to form a lenticular lens array of the desired characteristics. In one embodiment, the screen mesh is a 330-34 plain weave polyester mesh having a mesh count of about 330 tpi (threads per inch), a thread diameter of 34 micrometers and a mesh thickness of 53 micrometers.

The screen mesh is placed within a frame. It is preferred to stretch the screen mesh within the screen-printing frame at an angle relative to the printing direction (e.g., relative to the sides of the frame) to reduce interference with the parallel lines that can be caused by the mesh threads when the positive is imaged. For example, the screen mesh can be secured in the screen at an angle of about 22.50 relative to the screen frame and print direction.

A film positive is generated 562a that includes a series of positive parallel lines separated by negative parallel lines, where the positive parallel lines will form the lenticules of the lenticular lens array. The film positive can include parallel lines of a positive image separated by narrower lines of a negative image. For example, the positive image can include lines having a width of about 7 mils, separated by lines of a negative image having a width of about 2 mils. In addition, areas in which the lenticular lens array is not desired on the data storage card (e.g., the flush portions described with respect to FIGS. 1-3) can be removed from the positive image.

The screen-printing image is electronically generated and is scaled down to fit the individual data storage cards on the laminated sheet, and is placed into a step and repeat pattern. A screen is formed by coating the mesh screen with an emulsion and exposing the emulsion through the film positive 562b. Undeveloped portions of the emulsion are then washed away and screen is ready for printing.

The screen is disposed in a screen-printing apparatus and an ink is placed on the screen to be applied to the underlying laminated stack. The curable polymer ink can be a thixotropic, ultraviolet (UV) curable polymer ink, such as an ink identified as UVB-012 and available from Nor-Cote International, Inc., Crawfordsville, Ind., USA. The use of a thixotropic, UV curable ink allows the lenticular lens array to be reproduced accurately, retaining the shape of the lenticules, since the UV curable inks do not lose ink film thickness due to evaporation during the curing process. The ink is printed 562c by forcing the ink through the patterned mesh screen, such as by a squeegee that depresses the screen to contact the laminated stack as it traverses the screen.

After printing, the ink is rapidly cured 562 by passing the coated laminated stack under a UV lamp for a period of time sufficient to cure the ink and form the lenticular lens array. The lenticules are registered directly on top of the interlaced image to produce the desired lenticular effect.

### EXAMPLE

The following example illustrates a method for the manufacture of identification cards having a lenticular image feature. In this example, multiple identification cards are produced simultaneously in an array of 56 cards on a single sheet.

A screen-printing stencil is prepared for screen-printing the lenticular lens array. The screen mesh is a 330-34 plain weave polyester mesh having a mesh count of 330 tpi (threads per inch), a thread diameter of 34 μm and a mesh thickness of 53 μm. The mesh is stretched and secured in a rectangular frame at a 22.50 angle to the print direction to reduce interference with the parallel lines caused by the mesh threads when the positive is imaged.

A film positive is generated that includes a series of positive parallel lines separated by (negative) parallel lines, where the positive parallel lines will form the lenticules. The film positive includes 7 mil parallel lines of a positive image separated by 2 mil lines of a negative image. Areas in which the lenticular lens array is not desired (i.e., for logos, holograms, design considerations, etc.) are removed from the positive image.

Two coatings of emulsion are applied on each side of the screen using a wet coating method. The emulsion is dried and then exposed through the film positive and then developed to remove the emulsion and form the desired pattern. A lens array is screen-printed and cured and a pitch check instrument is used to determine the “pitch” of the lenticules. The pitch is measured in lpi (lenticules per inch) and is determined to be 111 lpi.

Artwork that will appear when viewing the front of the card and that comprises an interlaced image is prepared. The interlaced image is digitally created using the pitch of the lenticules in the lens array. The interlaced image is electronically generated and is scaled down to fit the individual cards on the substrate sheet. To determine the interlacing parameters for the interlaced image, the shrinkage characteristics of the cards during the heat lamination step is also determined. It is found that the image should be interlaced at 111.059 lpi to accommodate the shrinkage. In this manner, the final laminated interlaced image matches the pitch of the lens array (111 lpi) after shrinkage that occurs during heat lamination.

The image is then digitally interlaced to these dimensions. Lithographic printing plates are generated from this artwork as a reverse (mirror) image to accommodate second surface printing. Each printing plate is adapted to print 56 cards simultaneously onto a single sheet.

The printing plates are placed on a lithographic press, and the image layers are reproduced using a lithographic process. The images printed on the back of an optically clear PVC substrate having a thickness of about 13.5 mils. The images are reverse printed so that when the cards are viewed from the front, they appear right reading, a process referred to as second surface printing.

An opaque layer is then applied to the back of the printed image by screen-printing. The opaque layer is formed by printing three optically opaque inks sequentially onto the back of the interlaced image. The first ink is an optically opaque white ink, the second ink is a silver ink for increased opacity and the third ink is a white ink for aesthetics.

After printing of the opaque layer, the substrate is then collated with a second core stock substrate having a thickness of 13.5 mils, a front overlay film and a back overlay film. The front and back overlay films each consist of an optically transparent sheet of PVC having a thickness of about 1.8 mils. The back overlay film also includes a magnetic strip positioned to extend across the back surface of each card when the back overlay film is positioned over the substrate. Care is taken to preserve the integrity of the guide edges of the sheets, i.e., the sides of the sheets used in the printing processes to ensure proper registration from sheet to sheet. These guide edges are subsequently used as a fixed point to register the lenticular lens array to the image layer. The collated stack is tacked together by means of a sonic weld to hold the layers in alignment until they are heat laminated.

The collated stack is then sent through a heat lamination cycle. This cycle includes a press polish where the collated stack is placed between two polished platens. The platens are then heated to a peak temperature of about 310° F. while applying a pressure of about 255 psi to the collated stack. The peak lamination temperature is held for about 18 minutes. The laminated sheets are then placed in a cooling platen press, where the pressure is gradually increased during the cooling period to limit thermal contraction of the materials during cooling. The laminated sheets are held at 255 psi for one minute, at 300 psi for four minutes and then at 410 psi for thirteen minutes as the sheet gradually cools.

After cooling, the laminated sheet is removed from the press polish apparatus. The guide edge of the sheets is checked for distortion and the edges re-trimmed to ensure a fixed point of registration for the printing of the lenticular lens array.

The screen described above is placed in the screen-printer and an ink is placed on top of the screen. The ink utilized for the lenticular lens array is a thixotropic, UV curable ink (UVB012, available from Nor-Cote International, Inc., Crawfordsville, Ind.). The thixotropic nature of the ink allows the ink to maintain its shape in the stencil until shear force (the force of the squeegee) is applied, in which case it is transferred through the screen mesh. After it is deposited through the screen mesh onto the substrate, the ink retains its thixotropic character and substantially retains the shape into which it was printed

After printing of the ink, the ink is rapidly cured by conveying the sheet to a curing unit having two UV curing lamps with a wattage of 300 W/inch each. The sheet is moved at a linear speed of about 120 feet per minute under the lamps such that the ink is exposed to the UV lamps for several seconds. After curing of the ink, the data storage cards are punched from the sheet and subjected to finishing operations, such as embossing, foil tipping of the embossed areas, application of signature panels, holograms, personalization through various forms of post lamination printing, etc. The resulting data storage cards meet the requirements of ISO 7813 for financial transaction cards.

While various embodiments of the present invention have been described in detail, it is apparent that modifications and adaptations of those embodiments will occur to those skilled in the art. However, is to be expressly understood that such modifications and adaptations are within the spirit and scope of the present invention.

What is claimed is:

1. A method for the manufacture of a data storage card having a lenticular image feature, comprising the steps of:
printing an image layer comprising an interlaced image on a back surface of a substrate, the substrate comprising an optically transparent material;
collating the substrate with at least a first overlay film to form a multilayer collated stack;
heat laminating the multilayer collated stack to form a laminated stack; and
printing a lenticular lens array over a front surface of the laminated stack, whereby the interlaced image can be viewed through the lenticular lens array to form a lenticular image feature.

2. A method as recited in claim 1, wherein the step of printing an image layer comprises reverse printing an image on a back surface of the substrate.

3. A method as recited in claim 1, wherein the step of printing an image layer comprises reverse printing an image on a back surface of the substrate by lithographic printing.

4. A method as recited in claim 1, wherein the optically transparent material is a polymer material.

5. A method as recited in claim 1, wherein the optically transparent material is polyvinyl chloride.

6. A method as recited in claim 1, wherein the substrate has a thickness of at least about 24 mils and not greater than about 30 mils.

7. A method as recited in claim 1, wherein the step of printing a lenticular lens array over a front surface of the substrate comprises screen-printing an ink onto the front surface and curing the ink to form a lenticular lens array.

8. A method as recited in claim 1, wherein the step of printing a lenticular lens array over a front surface of the substrate comprises screen printing a UV curable ink onto a front surface of the substrate and curing the ink to form a lenticular lens array.

9. A method as recited in claim 1, wherein the step of printing a lenticular lens array over a front surface of the substrate comprises printing a lenticular lens array in a pre-determined pattern, whereby a portion of the front surface is not covered by the lenticular lens array to form a flush portion on the front surface.

10. A method as recited in claim 1, wherein the step of printing a lenticular lens array over a front surface of the substrate comprises printing a lenticular lens array in a pre-determined pattern, whereby a portion of the front surface is not covered by the lenticular lens array to form a flush portion of the front surface, and the method further comprising the step of applying a material layer to the flush portion.

11. A method as recited in claim 10, wherein the material layer applied to the flush portion comprises a hologram.

12. A method as recited in claim 1, further comprising the step of applying an optically opaque material behind the image layer.

13. A method as recited in claim 1, wherein said collating step comprises placing a front overlay film over a front surface of the substrate and placing a back overlay film under a back surface of the substrate behind the image layer.

14. A method as recited in claim 13, wherein said heat laminating step comprises placing the collated stack between two platens and applying elevated pressure and heat for a period of time sufficient to heat laminate the collated stack.

15. A method as recited in claim 14, wherein the front overlay film and the back overlay film are polymer films having a thickness that is less that the thickness of the substrate.

16. A method for the manufacture of a data storage card having a lenticular feature, comprising the steps of:
printing an image layer comprising an interlaced image on a back surface of a substrate, the substrate comprising an optically transparent polymer material;
applying an optically opaque material behind the interlaced image;
collating the substrate, a front overlay film and a back overlay film to form a multilayer collated stack;
heat laminating the multilayer collated stack to form a laminated stack;
screen printing a curable polymer ink onto the front of the laminated stack in a pattern that is adapted to form a lenticular lens array; and
curing the polymer ink to form a lenticular lens array over the front of the laminated stack, whereby the interlaced image can be viewed through the lenticular lens array to form a lenticular image feature.

17. A method as recited in claim 16, wherein the step of screen printing a polymer ink over the front of the laminated stack comprises screen printing the ink in a pre-determined pattern, whereby at least a portion of the front of the laminated stack is not covered by the lenticular lens array.

18. A method as recited in claim 16, wherein the step of screen printing an ink over the front of the laminated stack comprises printing the ink in a pre-determined pattern, whereby at least a portion of the front of the laminated stack is not covered by the lenticular lens array, and further comprising the step of hot stamping a material layer onto the portion that is not covered by the lenticular lens array.

19. A method as recited in claim 16, further comprising the step of printing alphanumeric characters on a front surface of the substrate before the collating step.

20. A method as recited in claim 16, wherein the optically opaque material is opaque to light in the infrared spectrum.

21. An identification card, comprising:
a substrate having a front surface and an opposed back surface and comprising an optically transparent material;
an image layer comprising an interlaced image that is reverse printed on the back surface of the substrate;
an optically opaque layer disposed behind the image layer;
a front overlay film heat-laminated on the front surface of the substrate; and
a lenticular lens array disposed over the front overlay film, whereby the interlaced image can be viewed through the lenticular lens array and the substrate.

22. An identification card as recited in claim 21, further comprising a back overlay film heat laminated on the back surface of the optically opaque layer.

23. An identification card as recited in claim 21, wherein the front overlay film comprises optically transparent polyvinyl chloride.

24. An identification card as recited in claim 21, wherein the optically transparent substrate material is a polymeric material.

25. An identification card as recited in claim 21, wherein the optically transparent substrate material is polyvinyl chloride.

26. An identification card as recited in claim 21, wherein the substrate has a thickness of at least about 24 mils and not greater than about 30 mils.

27. An identification card as recited in claim 21, wherein the identification card is a financial transaction card.

28. An identification card as recited in claim 21, further comprising a magnetic strip disposed on a back surface of the identification card.

29. An identification card as recited in claim 21, wherein the lenticular lens array comprises a UV cured polymer.

30. An identification card as recited in claim 21, further comprising a security feature disposed on a front side of the identification card.

31. An identification card as recited in claim 30, wherein the security feature comprises a hologram.
